(19) United States
(12) Patent Application Publication
(10) Pub. No.: US 2025/0159557 A1
(43) Pub. Date: May 15, 2025

(54) DATA PACKET PROCESSING METHOD, TERMINAL, AND NETWORK SIDE DEVICE

(71) Applicant: VIVO MOBILE COMMUNICATION CO., LTD., Dongguan (CN)

(72) Inventor: Wei BAO, Dongguan (CN)

(73) Assignee: VIVO MOBILE COMMUNICATION CO., LTD., Dongguan (CN)

(21) Appl. No.: 19/026,323

(22) Filed: Jan. 16, 2025

Related U.S. Application Data
(63) Continuation of application No. PCT/CN2023/107241, filed on Jul. 13, 2023.

(30) Foreign Application Priority Data
Jul. 18, 2022 (CN) 202210845357.4

(51) Int. Cl. H04W 36/00; H04L 1/1867; H04W 72/21

(52) U.S. Cl. CPC H04W 36/0033; H04L 1/1887; H04W 72/21

(57) ABSTRACT

This application provides a data packet processing method, a terminal, and a network side device. The data packet processing method includes: a terminal determines that a first uplink data packet has not been successfully transmitted in a source cell; and the terminal executes target behavior. The terminal does not transmit the first uplink data packet in a target cell. The source cell is a source cell in a cell handover procedure. The target cell is a target cell in the cell handover procedure. The target behavior includes at least one of the following: discarding a second uplink data packet; or not transmitting the second uplink data packet in the target cell. The second uplink data packet is an uplink data packet in an association relationship with the first uplink data packet.

### CROSS-REFERENCE TO RELATED APPLICATIONS

This application is a continuation of International Application No. PCT/CN 2023/107241, filed on Jul. 13, 2023, which claims priority to Chinese Patent Application No. 202210845357.4, filed on Jul. 18, 2022. The entire contents of each of the above-referenced applications are expressly incorporated herein by reference.

### TECHNICAL FIELD

This application pertains to the field of communication technologies, and specifically, to a data packet processing method, a terminal, and a network side device.

### BACKGROUND

In some communication systems, in a handover scenario in which a terminal is handed over from a source cell to a target cell, the terminal transmits all untransmitted data packets in the target cell, and a source network side device also sends, to a target network side device, all data packets that are not sent to the terminal. This causes excessive network resource overheads.

### SUMMARY

Embodiments of this application provide a data packet processing method, a terminal, and a network side device.

According to a first aspect, a data packet processing method is provided, including:
determining, by a terminal, that a first uplink data packet has not been successfully transmitted in a source cell, where the terminal does not transmit the first uplink data packet in a target cell, the source cell is a source cell in a cell handover procedure, and the target cell is a target cell in the cell handover procedure; and
executing, by the terminal, target behavior, where the target behavior includes at least one of the following:
discarding a second uplink data packet; and
not transmitting the second uplink data packet in the target cell; where
the second uplink data packet is an uplink data packet in an association relationship with the first uplink data packet.

According to a second aspect, a data packet processing method is provided, including:
determining, by a source network side device, that a first downlink data packet has not been successfully transmitted in a source cell, where the source network side device does not send the first downlink data packet to a target network side device of a target cell, the source cell is a source cell in a cell handover procedure, and the target cell is a target cell in the cell handover procedure; and
executing, by the source network side device, target behavior, where the target behavior includes at least one of the following:
discarding a second downlink data packet; and
not sending the second downlink data packet to the target network side device; where
the second downlink data packet is a downlink data packet in an association relationship with the first downlink data packet.

According to a third aspect, a data packet processing apparatus is provided, including:
a determining module, configured to determine that a first uplink data packet has not been successfully transmitted in a source cell, where a terminal does not transmit the first uplink data packet in a target cell, the source cell is a source cell in a cell handover procedure, and the target cell is a target cell in the cell handover procedure; and
an execution module, configured to execute target behavior, where the target behavior includes at least one of the following:
discarding a second uplink data packet; and
not transmitting the second uplink data packet in the target cell; where
the second uplink data packet is an uplink data packet in an association relationship with the first uplink data packet.

According to a fourth aspect, a data packet processing apparatus is provided, including:
a determining module, configured to determine that a first downlink data packet has not been successfully transmitted in a source cell, where a source network side device does not send the first downlink data packet to a target network side device of a target cell, the source cell is a source cell in a cell handover procedure, and the target cell is a target cell in the cell handover procedure; and
an execution module, configured to execute target behavior, where the target behavior includes at least one of the following:
discarding a second downlink data packet; and
not sending the second downlink data packet to the target network side device; where
the second downlink data packet is a downlink data packet in an association relationship with the first downlink data packet.

According to a fifth aspect, a terminal is provided, including a processor and a memory. The memory stores a program or an instruction that can be run on the processor, and when the program or the instruction is executed by the processor, the steps of the data packet processing method on a terminal side according to the embodiments of this application are implemented.

According to a sixth aspect, a terminal is provided, including a processor and a communication interface. The processor or the communication interface is configured to determine that a first uplink data packet has not been successfully transmitted in a source cell, where the terminal does not transmit the first uplink data packet in a target cell, the source cell is a source cell in a cell handover procedure, and the target cell is a target cell in the cell handover procedure. The processor or the communication interface is further configured to execute target behavior, where the target behavior includes at least one of the following: discarding a second uplink data packet; and not transmitting the second uplink data packet in the target cell; where the second uplink data packet is an uplink data packet in an association relationship with the first uplink data packet.

According to a seventh aspect, a network side device is provided, including a processor and a memory. The memory stores a program or an instruction that can be run on the processor, and when the program or the instruction is executed by the processor, the steps of the data packet processing method on a network side device side according to the embodiments of this application are implemented.

According to an eighth aspect, a network side device is provided, including a processor and a communication interface. The processor or the communication interface is configured to determine that a first downlink data packet has not been successfully transmitted in a source cell, where a source network side device does not send the first downlink data packet to a target network side device of a target cell, the source cell is a source cell in a cell handover procedure, and the target cell is a target cell in the cell handover procedure. The processor or the communication interface is further configured to execute target behavior, where the target behavior includes at least one of the following: discarding a second downlink data packet; and not sending the second downlink data packet to the target network side device; where the second downlink data packet is a downlink data packet in an association relationship with the first downlink data packet.

According to a ninth aspect, a readable storage medium is provided. A program or an instruction is stored in the readable storage medium, and when the program or the instruction is executed by a processor, the steps of the data packet processing method on a terminal side according to the embodiments of this application are implemented, or when the program or the instruction is executed by a processor, the steps of the data packet processing method on a network side device side according to the embodiments of this application are implemented.

According to a tenth aspect, a chip is provided. The chip includes a processor and a communication interface, the communication interface is coupled to the processor, and the processor is configured to run a program or an instruction to implement the steps of the data packet processing method on a terminal side according to the embodiments of this application, or the processor is configured to run a program or an instruction to implement the steps of the data packet processing method on a network side device side according to the embodiments of this application.

According to an eleventh aspect, a computer program/program product is provided. The computer program/program product is stored in a storage medium, and the computer program/program product is executed by at least one processor to implement the steps of the data packet processing method on a terminal side according to the embodiments of this application, or the computer program/program product is executed by at least one processor to implement the steps of the data packet processing method on a network side device side according to the embodiments of this application.

According to a twelfth aspect, a data packet processing system is provided, including a terminal and a network side device. The terminal may be configured to perform the steps of the data packet processing method on a terminal side according to the embodiments of this application, and the network side device may be configured to perform the steps of the data packet processing method on a network side device side according to the embodiments of this application.

In the embodiments of this application, a terminal determines that a first uplink data packet has not been successfully transmitted in a source cell, where the terminal does not transmit the first uplink data packet in a target cell, the source cell is a source cell in a cell handover procedure, and the target cell is a target cell in the cell handover procedure; and the terminal executes target behavior, where the target behavior includes at least one of the following: discarding a second uplink data packet; and not transmitting the second uplink data packet in the target cell; where the second uplink data packet is an uplink data packet in an association relationship with the first uplink data packet. In this way, because at least one of discarding the second uplink data packet and not transmitting the second uplink data packet in the target cell is performed, resource overheads can be reduced.

### BRIEF DESCRIPTION OF DRAWINGS

FIG. 1 is a block diagram of a wireless communication system to which embodiments of this application are applicable;

FIG. 2 is a flowchart of a data packet processing method according to an embodiment of this application;

FIG. 3 is a schematic diagram of data packet transmission according to an embodiment of this application;

FIG. 4 is a schematic diagram of another data packet transmission according to an embodiment of this application;

FIG. 5 is a flowchart of another data packet processing method according to an embodiment of this application;

FIG. 6 is a structural diagram of a data packet processing apparatus according to an embodiment of this application;

FIG. 7 is a structural diagram of another data packet processing apparatus according to an embodiment of this application;

FIG. 8 is a structural diagram of a communication device according to an embodiment of this application;

FIG. 9 is a structural diagram of a terminal according to an embodiment of this application; and

FIG. 10 is a structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} Generation (6G) communication system.

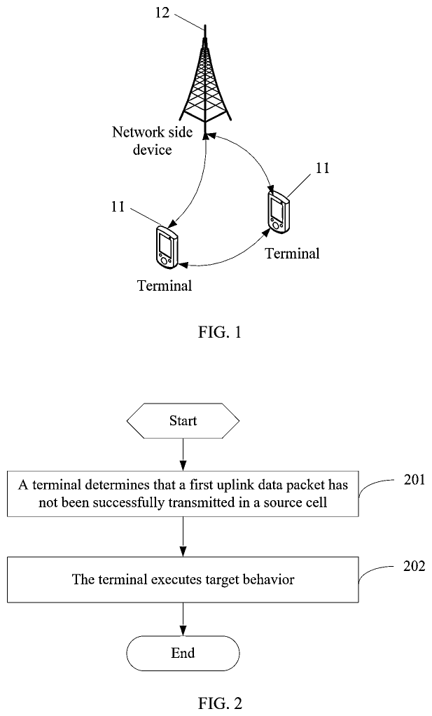

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer (Laptop Computer) that is also referred to as a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home device (a home device with a wireless communication function, such as a refrigerator, a television, a washing machine, or furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet bracelet, a smart anklet chain, or the like), a smart wrist strap, a smart dress, and the like. It should be noted that a specific type of the terminal 11 is not limited in the embodiments of this application. The network side device 12 may include an access network device or a core network device. The network side device 12 may also be referred to as a radio access network device, a Radio Access Network (RAN), a radio access network function, or a radio access network unit. The network side device 12 may include a base station, a Wireless Local Area Network (WLAN) access point, a WiFi node, or the like. The base station may be referred to as a NodeB, an Evolved Node B (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another proper term in the art. The base station is not limited to a specific technical term provided that a same technical effect is achieved. It should be noted that in the embodiments of this application, a base station in an NR system is merely used as an example for description, but does not limit a specific type of the base station. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), Unified Data Repository (UDR), a Home Subscriber Server (HSS), Centralized network configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

With reference to the accompanying drawings, a data packet processing method, a terminal, and a network side device in the embodiments of this application are described in detail below by using specific embodiments and application scenarios thereof.

FIG. 2 is a flowchart of a data packet processing method according to an embodiment of this application. As shown in FIG. 2, the method includes the following steps:

Step 201: A terminal determines that a first uplink data packet has not been successfully transmitted in a source cell, where the terminal does not transmit the first uplink data packet in a target cell, the source cell is a source cell in a cell handover procedure, and the target cell is a target cell in a cell handover procedure.

The foregoing “has not been successfully transmitted in a source cell” may be that the terminal has not sent the first uplink data packet on an air interface, or the terminal has sent the first uplink data packet but a source network side device to which the source cell belongs has not successfully received or decoded the first uplink data packet.

In this embodiment of this application, the first uplink data packet includes but is not limited to at least one of the following:

an application layer data packet, a Packet Data Convergence Protocol (PDCP) Protocol Data Unit (PDU), a Service Data Unit (SDU), a Radio Link Control (RLC) SDU, an RLC PDU, and the like.

That the terminal does not transmit the first uplink data packet in the target cell may be understood as follows: In a case that the first uplink data packet has not been successfully transmitted in the source cell, the terminal does not transmit the first uplink data packet in the target cell.

Step 202: The terminal executes target behavior, where the target behavior includes at least one of the following:
discarding a second uplink data packet; and
not transmitting the second uplink data packet in the target cell; where
the second uplink data packet is an uplink data packet in an association relationship with the first uplink data packet.

That the terminal executes the target behavior may be understood as follows: The target behavior is executed in a case that it is determined that the first uplink data packet has not been successfully transmitted in the source cell.

The association relationship between the second uplink data packet and the first uplink data packet may be an association relationship defined in a protocol, may be an association relationship configured on a network side, or may be an association relationship notified by a higher layer of the terminal. Herein, the higher layer refers to an application layer on a terminal side, a protocol layer above PDCP of the terminal, or a protocol layer above a Service Data Adaptation Protocol (SDAP). For example, the second uplink data packet is in a decoding dependency relationship with the first uplink data packet, that is, decoding of one data packet depends on another data packet. For example, the second uplink data packet is in an application dependency relationship with the first uplink data packet, that is, application of one data packet depends on another data packet.

In this embodiment of this application, through the foregoing steps, in a case that the first uplink data packet has not been successfully transmitted in the source cell, at least one of discarding the second uplink data packet and not transmitting the second uplink data packet in the target cell is performed, so that resource overheads can be reduced.

In some embodiments, that the first uplink data packet has not been successfully transmitted in the source cell includes at least one of the following:
the terminal has not transmitted the first uplink data packet on an air interface of the source cell;
the terminal has transmitted the first uplink data packet on the air interface, but the terminal receives retransmission scheduling signaling sent by a source network side device for the first uplink data packet, and before terminating data transmission with the source cell, the terminal has not performed retransmission corresponding to the retransmission scheduling signaling;
the terminal receives first indication information from the source network side device or a target network side device, where the first indication information indicates an uplink data packet successfully received by the source network side device, and the data packet successfully received by the source network side device does not include the first uplink data packet; and
the terminal receives second indication information from the source network side device or the target network side device, where the second indication information indicates an uplink data packet that is not successfully received by the source network side device, and the first uplink data packet is an uplink data packet that is not successfully received by the source network side device.

That the terminal has not transmitted the first uplink data packet on the air interface of the source cell may be that the terminal has not transmitted the first uplink data packet on the air interface of the source cell, for example, the higher layer (for example, a PDCP layer) of the terminal sends the first uplink data packet to a lower layer (for example, a physical layer), but the lower layer has not transmitted the first uplink data packet on the air interface of the source cell.

That the terminal has transmitted the first uplink data packet on the air interface, but the terminal receives the retransmission scheduling signaling sent by the source network side device for the first uplink data packet may be as follows: The terminal has transmitted the first uplink data packet on the air interface, but the network side device has not successfully received or decoded the first uplink data packet, so that the source network side device sends the retransmission scheduling signaling to the terminal.

The retransmission scheduling signaling for the first uplink data packet may be that the terminal transmits the first uplink data packet by using a Hybrid Automatic Repeat Request (HARQ) process X, receives the retransmission scheduling signaling sent by the source network side device, and instructs the terminal to retransmit the HARQ process X.

That the terminal has not performed retransmission corresponding to the retransmission scheduling signaling before terminating data transmission with the source cell may be as follows: After receiving the scheduling signaling, the terminal has not performed retransmission of the first uplink data packet in the source cell.

In some implementations, the retransmission scheduling signaling includes scheduling signaling for N retransmissions, and that retransmission corresponding to the retransmission scheduling signaling has not been performed includes:
an N^{th} retransmission for the first uplink data packet has not been performed; where
N is a positive integer.

In this implementation, in a case that the scheduling signaling for N retransmissions is received, if the N^{th} retransmission for the first uplink data packet has not been performed, the first uplink data packet is not transmitted in the target cell, so that transmission resources are further saved.

In this implementation, the data packet successfully received by the source network side device is used to implicitly indicate that the first uplink data packet has not been successfully transmitted in the source cell. A data packet that is not successfully received by the source network side device can be used to explicitly indicate that the first uplink data packet has not been successfully transmitted in the source cell.

In this implementation, whether the first uplink data packet has not been successfully transmitted in the source cell can be determined from multiple dimensions, to improve flexibility of data packet processing.

It should be noted that, in this embodiment of this application, the source network side device corresponds to the source cell, and the target network side device corresponds to the target cell.

In some embodiments, the second uplink data packet includes at least one of the following:
in a case that the first uplink data packet has not been successfully transmitted, a data packet that is unable to be applied by a communication peer of the terminal;
in a case that the first uplink data packet has not been successfully transmitted, an uplink data packet in which information is unable to be applied by the communication peer of the terminal; and
in a case that the first uplink data packet has not been successfully transmitted, a data packet that is unable to be correctly decoded by the communication peer of the terminal.

The communication peer of the terminal may include at least one of the following:
an application server or another terminal that communicates with the terminal.

The data packet that is unable to be applied by the communication peer may be that the communication peer successfully receives the data packet, and because the first uplink data packet has not been obtained, the data packet cannot be applied, for example, cannot be displayed, or information is missing after being displayed.

If the second uplink data packet is a packet of a lower layer, such as a packet of the PDCP, the second uplink data packet is not transmitted to the communication peer. That the information in the second uplink data packet cannot be applied by the communication peer of the terminal may mean that if a base station decapsulates the second uplink data packet and sends a payload part of the second uplink data packet to the communication peer, the communication peer cannot apply the payload part. For example, the information in the second data packet cannot be applied because information about the first uplink data packet has not been obtained. Therefore, the terminal discards or does not transmit the second uplink data packet.

In this implementation, data packets (these data packets may be referred to as invalid data packets) that cannot be applied or correctly decoded by the communication peer of the terminal can be discarded or not transmitted, to reduce resource overheads and further reduce power consumption of the communication peer.

An embodiment is as follows:

A specific correlation exists between some data packets carrying an Extended reality (XR) service. For example, one group of data packets compose one picture. If a data packet (for example, a data packet carrying important data) in the group of data packets is lost or incorrect due to a transmission problem, the entire group of data packets cannot be displayed. For another example, correct display of a data packet group B depends on correct reception of a data packet group A. If a receive end cannot decode the data packet group B due to a transmission problem, for example, loss or an error, information carried in the data packet group A has no significance even if the information is correctly transmitted to the receive end.

Video data is encoded and decoded in a manner of an image set or a Group of pictures (GoP). Video service data is grouped into a set of several consecutive pictures, that is, multiple GoPs, where each GoP includes a group of consecutive and associated image frames (each frame is one picture). Generally, a first frame of each GoP frame is an Intra frame (I frame) or an Instantaneous decoder refresh (IDR) frame, and is characterized by being capable of being independently decoded without relying on information carried in another frame in the same GoP. Therefore, the I frame or the IDR frame is also referred to as a key frame. Another frame in each GoP is a predictive frame (Predictive-Frame (P frame)) or a bi-directional interpolated prediction frame (B frame), and cannot be independently decoded into an image. Instead, a decoder needs to perform joint decoding by using information carried in the decoder and information of an I frame or an IDR frame that is associated with the decoder and that belongs to a same GoP, to generate a corresponding picture. In other words, if an I frame or an IDR frame in a specific GoP has not been successfully decoded, other frames in the same GoP cannot be successfully decoded. In other words, in this case, this is meaningless for decoding of any other frame in a GoP.

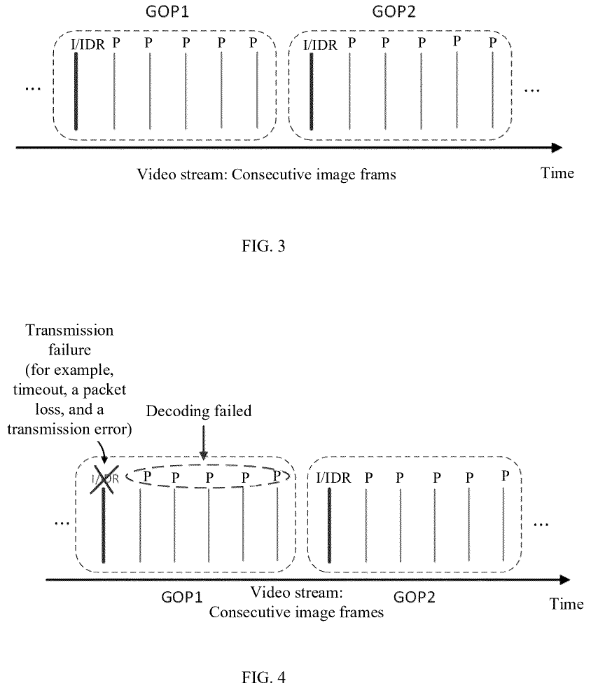

FIG. 3 shows an example of a video stream. For simplicity, this figure includes only a key frame (I frame/IDR frame) and a P frame. A GOP 1 is used as an example. If an I frame/IDR frame included in the GOP 1 has not been successfully decoded, images corresponding to all P frames in the same GOP subsequently fail to be decoded, and a video picture corresponding to the entire GOP 1 cannot be played normally.

Further, in a wireless network, video data encoded by a video encoder of the terminal (uplink)/server (downlink) needs to be transmitted to a video decoder of a server (uplink)/terminal (downlink) for decoding by using a wireless communication network. In view of coding and decoding characteristics of the foregoing video service, if data of an I-frame/IDR frame has not been successfully transmitted to an entity corresponding to the video decoder by using a wireless network, due to a caused decoding failure of the I-frame/IDR frame, further, any video frame belonging to a same GoP cannot be successfully decoded. The following figure is an example. If the I frame/IDR frame in the GOP 1 has not been successfully transmitted in a wireless transmission process due to transmission timeout, a transmission error, or the like, for another P frame of a same GOP, regardless of whether subsequent data transmission succeeds, a decoder end cannot successfully decode the another P frame, and consequently, image decoding in the entire GOP 1 fails. For details, refer to FIG. 4.

It should be noted that the foregoing embodiment is merely described by using an XR service as an example. In this embodiment of this application, the first uplink data packet and the second uplink data packet may be uplink data packets in an association relationship with another service, for example, uplink data packets in an association relationship with another service in an automatic driving technology.

In some embodiments, the first uplink data packet and the second uplink data packet belong to a same data packet group, or the first uplink data packet and the second uplink data packet belong to associated data packet groups; or the third uplink data packet and the fourth uplink data packet belong to a same data packet group, or the third uplink data packet and the fourth uplink data packet belong to associated data packet groups, where the third uplink data packet carries the first uplink data packet, and the fourth uplink data packet carries the second uplink data packet.

The foregoing data packet group may be a PDU set.

That the first uplink data packet and the second uplink data packet belong to associated data packet groups may be understood as follows: The first uplink data packet and the second uplink data packet respectively belong to different data packet groups, and the different data packet groups are associated data packet groups. The association relationship may be defined in a protocol, configured on a network side, or indicated by an application layer.

That the third uplink data packet carries the first uplink data packet may be as follows: The first uplink data packet is a payload part of the third uplink data packet. That the fourth uplink data packet carries the second uplink data packet may be as follows: The second uplink data packet is a payload part of the fourth data packet.

In this implementation, in a case that the first uplink data packet in a same data packet group has not been successfully transmitted in the source cell, another uplink data packet in the data packet group can be discarded or not transmitted in the target cell, to reduce resource overheads.

In some implementations, the first uplink data packet may be any uplink data packet in the data packet group, or the first uplink data packet may be a key data packet in the data packet group.

In some embodiments, the method further includes:
the terminal sends a fifth uplink data packet in the target cell, where the fifth uplink data packet includes:
an uplink data packet other than the first uplink data packet and the second uplink data packet.

In this implementation, only the second uplink data packet associated with the first uplink data packet can be discarded or not transmitted in the target cell, but another data packet is transmitted, to improve transmission performance of the terminal.

It should be noted that, in this embodiment of this application, the first uplink data packet, the second uplink data packet, and the third data packet may refer to one or more data packets.

In some embodiments, that the terminal executes target behavior includes:
the terminal executes the target behavior in the cell handover procedure.

In this implementation, the second uplink data packet can be discarded in the cell handover procedure or the second uplink data packet is not transmitted in the target cell, so that resource overheads in the cell handover procedure are reduced.

In some implementations, for example, after being handed over to the target cell, the terminal discards the second uplink data packet or does not transmit the second uplink data packet in the target cell.

It should be noted that in this embodiment of this application, in a case that the target behavior includes that the target cell does not transmit the second uplink data packet, executing the target behavior may also be understood as determining the target behavior, that is, determining that the second uplink data packet is not transmitted in the target cell.

It should be noted that, in this embodiment of this application, discarding the second uplink data packet or not transmitting the second uplink data packet in the target cell does not cause disconnection or re-establishement of a radio connection between the terminal and the network side, for example, does not cause disconnection or re-establishement of Radio Resource Control (RRC).

In this embodiment of this application, the terminal determines that the first uplink data packet has not been successfully transmitted in the source cell, where the terminal does not transmit the first uplink data packet in the target cell, the source cell is a source cell in the cell handover procedure, and the target cell is a target cell in the cell handover procedure; and the terminal executes the target behavior, where the target behavior includes at least one of the following: discarding the second uplink data packet; and not transmitting the second uplink data packet in the target cell; where the second uplink data packet is an uplink data packet in an association relationship with the first uplink data packet. In this way, because at least one of discarding the second uplink data packet and not transmitting the second uplink data packet in the target cell is performed, resource overheads can be reduced.

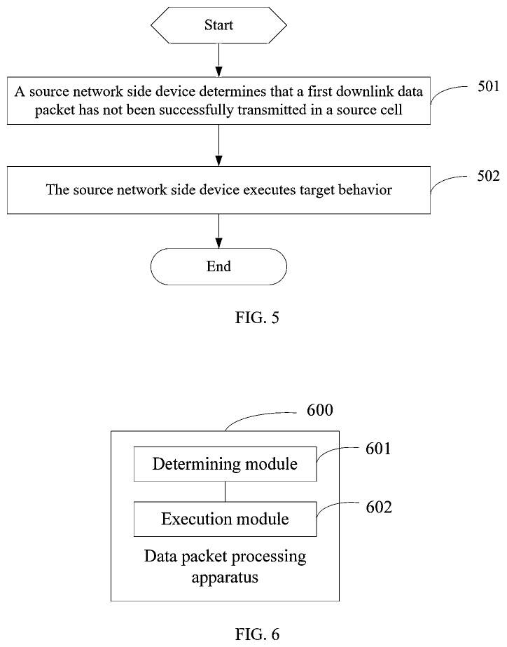

FIG. 5 is a flowchart of a data packet processing method according to an embodiment of this application. As shown in FIG. 5, the method includes the following steps:

Step 501: A source network side device determines that a first downlink data packet has not been successfully transmitted in a source cell, where the source network side device does not send the first downlink data packet to a target network side device of a target cell, the source cell is a source cell in a cell handover procedure, and the target cell is a target cell in the cell handover procedure.

Step 502: The source network side device executes target behavior, where the target behavior includes at least one of the following:
discarding a second downlink data packet; and
not sending the second downlink data packet to the target network side device; where
the second downlink data packet is a downlink data packet in an association relationship with the first downlink data packet.

In some embodiments, that the first downlink data packet has not been successfully transmitted includes at least one of the following:
the source network side device has not transmitted the first downlink data packet on an air interface of the source cell;
the source network side device has transmitted the first downlink data packet on the air interface of the source cell, but the source network side device receives a Negative Acknowledgement (NACK) sent by the terminal for the first downlink data packet, and the source network side device does not retransmit the first downlink data packet;
the source network side device receives first indication information of a terminal, where the first indication information indicates a downlink data packet successfully received by the terminal, and the downlink data packet successfully received by the terminal does not include the first downlink data packet; and
the source network side device receives second indication information of the terminal, where the second indication information indicates a downlink data packet that is not successfully received by the terminal, and the first downlink data packet is a downlink data packet that is not successfully received by the terminal.

The NACK may be one of a HARQ NACK, an RLC NACK, and the like.

The first indication information and the second indication information may be sent by the terminal to the source network side device, or may be indication information that is forwarded or forwarded after being processed by the target network side device.

In some embodiments, the NACK includes N NACKs, and that the source network side device has not retransmitted the first downlink data packet includes:
the source network side device has not performed an N^{th} retransmission for the first downlink data packet; where
N is a positive integer.

In this implementation, the source network side device first performs initial transmission of the first downlink data packet, then performs NACK once, and performs retransmission once.

In some embodiments, the second downlink data packet includes at least one of the following:
in a case that the first downlink data packet has not been successfully transmitted, a downlink data packet that is unable to be applied by the terminal;
in a case that the first downlink data packet has not been successfully transmitted, a downlink data packet in which information is unable to be applied by the terminal; and
in a case that the first downlink data packet has not been successfully transmitted, a data packet that is unable to be correctly decoded by the terminal.

The terminal herein may be a terminal that performs air interface communication with the source network side device.

In some embodiments, the first downlink data packet and the second downlink data packet belong to a same data packet group, or the first downlink data packet and the second downlink data packet belong to associated data packet groups; or
the third downlink data packet and the fourth downlink data packet belong to a same data packet group, or the third downlink data packet and the fourth downlink data packet belong to associated data packet groups, where the third downlink data packet carries the first downlink data packet, and the fourth downlink data packet carries the second downlink data packet. In some embodiments, the method further includes:

the source network side device sends a fifth downlink data packet to the target network side device, where the fifth downlink data packet includes:
a downlink data packet other than the first downlink data packet and the second downlink data packet.

In some embodiments, that the source network side device executes target behavior includes:
the source network side device executes the target behavior in the cell handover procedure.

In this embodiment, because at least one of discarding the second downlink data packet and not sending the second downlink data packet to the target network side device is performed, resource overheads can be reduced.

It should be noted that this embodiment is used as an implementation of the network side device corresponding to the embodiment shown in FIG. 2. For a specific implementation of this embodiment, reference may be made to the related descriptions of the embodiment shown in FIG. 2. To avoid repetition, details are not described in this embodiment again.

The method provided in the embodiments of this application is described as examples below by using multiple embodiments:

### Embodiment 1

In this embodiment, as an example for description, an uplink data packet A/B has not been successfully received by a source cell, and a terminal sends, to a target cell, a packet that is not associated with the data packet A/B. For example, the following steps may be included.

Step 1: The terminal receives a handover command and stops sending a signal to a source cell.

Step 2: The terminal determines a data packet that needs to be discarded, where the terminal determines that the data packet that needs to be discarded includes one or more of the following:
a data packet (referred to as a packet A below) that is sent by a PDCP layer of the terminal to a lower layer but the lower layer has not yet transmitted on an air interface;
a data packet (referred to as a packet B below) that has been transmitted by the terminal on an air interface, but for which an N^{th} (N≥1) retransmission has not been performed in a case that scheduling signaling for N retransmissions sent by a network side for a resource block including the data packet is received; and
a packet (packet C) associated with the packet A/B in a case that A/B is a key packet, where
the key packet includes a data packet that needs to correctly received so as to correctly decode another data packet; and/or
the packet A/B and the packet C may belong to a same data packet group or associated data packet groups.

Step 3: The terminal sends an uplink data packet other than A/B/C in a target cell.

### Embodiment 2

In this embodiment, as an example for description, a downlink data packet A/B sent in a source cell has not been correctly received by a terminal, and a source base station forwards a data packet that is not associated with the packet A/B to a target base station. For example, the following steps may be included.

Step 1: The source cell sends a handover command to the terminal.

Step 2: The source base station determines a data packet that needs to be discarded, where the source base station determines that the data packet that needs to be discarded includes one or more of the following:
a data packet (referred to as a packet A below) that is sent by a PDCP layer of the source base station to a lower layer but the lower layer has not yet transmitted on an air interface;
a data packet (referred to as a packet B below) that has been transmitted by the source base station on an air interface, but for which an (N+1)th (N≥1) retransmission has not been performed in a case that N NACKs (for example, HARQ NACKs) sent by the terminal for a resource block including the data packet are received; and
a packet (packet C) associated with the packet A/B in a case that A/B is a key packet, where
the key packet is a packet that needs to correctly received so as to correctly decode another packet; and/or
the packet A/B and the packet C may belong to a same data packet group or associated data packet groups.

Step 3: The source base station forwards a data packet other than A/B/C to the target base station.

Step 4: The target base station sends the received forwarded data packet to the terminal.

This embodiment of this application may be implemented as follows:

After determining that a first data packet has not been successfully transmitted, the terminal or the source base station discards a second data packet in an association relationship with the first data packet based on association characteristics of the first data packet. In a handover process, for an uplink, the terminal does not send the second data packet in a target cell, and for a downlink, the source base station does not forward the second data packet to the target base station;
the terminal sends, in the target cell, an uplink data packet other than C (the second data packet); and
the source base station forwards a downlink data packet other than C (the second data packet) to the target base station; where
a determining mechanism of the data packet C may be: first determining the data packet A/B (the first data packet), and then determining the data packet C (the second data packet) based on an association relationship between the data packets;
the data packet A includes a data packet that is sent by a PDCP of the terminal/base station to a lower layer in the source cell but the lower layer has not yet transmitted on an air interface;
the data packet B includes an uplink data packet for which the terminal receives initial transmission/retransmission scheduling in the source cell but has not performed initial transmission/retransmission, and a downlink data packet for which the base station receives a transmission failure feedback (for example, a HARQ NACK) but has not performed retransmission; and
the data packet C includes a data packet that cannot be applied or correctly decoded in a case that the data packet A/B is not received.

In this embodiment of this application, a resource waste caused by performing subsequent invalid transmission on related data due to a transmission failure/packet loss (for example, an I frame) of key data can be avoided.

Referring to FIG. 6, FIG. 6 is a structural diagram of a data packet processing apparatus according to an embodiment of this application. As shown in FIG. 6, the data packet processing apparatus 600 includes:
a determining module 601, configured to determine that a first uplink data packet has not been successfully transmitted in a source cell, where a terminal does not transmit the first uplink data packet in a target cell, the source cell is a source cell in a cell handover procedure, and the target cell is a target cell in the cell handover procedure; and
an execution module 602, configured to execute target behavior, where the target behavior includes at least one of the following:
discarding a second uplink data packet; and
not transmitting the second uplink data packet in the target cell; where
the second uplink data packet is a data packet in an association relationship with the first uplink data packet.

The data packet processing apparatus corresponds to the terminal, or the terminal includes the data packet processing apparatus.

In some embodiments, that the first uplink data packet has not been successfully transmitted in the source cell includes at least one of the following:
the terminal has not transmitted the first uplink data packet on an air interface of the source cell;
the terminal has transmitted the first uplink data packet on the air interface, but the terminal receives retransmission scheduling signaling sent by a source network side device for the first uplink data packet, and before terminating data transmission with the source cell, the terminal has not performed retransmission corresponding to the retransmission scheduling signaling;
the terminal receives first indication information from the source network side device or a target network side device, where the first indication information indicates an uplink data packet successfully received by the source network side device, and the uplink data packet successfully received by the source network side device does not include the first uplink data packet; and
the terminal receives second indication information from the source network side device or the target network side device, where the second indication information indicates an uplink data packet that is not successfully received by the source network side device, and the first uplink data packet is an uplink data packet that is not successfully received by the source network side device.

In some embodiments, the retransmission scheduling signaling includes scheduling signaling for N retransmissions, and that retransmission corresponding to the retransmission scheduling signaling has not been performed includes:
an N^{th} retransmission for the first uplink data packet has not been performed; where
N is a positive integer.

In some embodiments, the second uplink data packet includes at least one of the following:
in a case that the first uplink data packet has not been successfully transmitted, a data packet that is unable to be applied by a communication peer of the terminal;
in a case that the first uplink data packet has not been successfully transmitted, an uplink data packet in which information is unable to be applied by the communication peer of the terminal; and
in a case that the first uplink data packet has not been successfully transmitted, a data packet that is unable to be correctly decoded by the communication peer of the terminal.

In some embodiments, the first uplink data packet and the second uplink data packet belong to a same data packet group, or the first uplink data packet and the second uplink data packet belong to associated data packet groups; or the third uplink data packet and the fourth uplink data packet belong to a same data packet group, or the third uplink data packet and the fourth uplink data packet belong to associated data packet groups, where the third uplink data packet carries the first uplink data packet, and the fourth uplink data packet carries the second uplink data packet.

In some embodiments, the apparatus further includes:
a sending module, configured to send a fifth uplink data packet in the target cell, where the fifth uplink data packet includes:
an uplink data packet other than the first uplink data packet and the second uplink data packet.

In some embodiments, the executing target behavior includes:
executing the target behavior in the cell handover procedure.

The foregoing data packet processing apparatus can reduce resource overheads.

The data packet processing apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the types of terminals listed in the embodiments of this application, and the another device may be a server, a Network Attached Storage (NAS), or the like. This is not specifically limited in this embodiment of this application.

The data packet processing apparatus provided in this embodiment of this application can implement the processes implemented in the method embodiment shown in FIG. 2, and a same technical effect is achieved. To avoid repetition, details are not provided herein again.

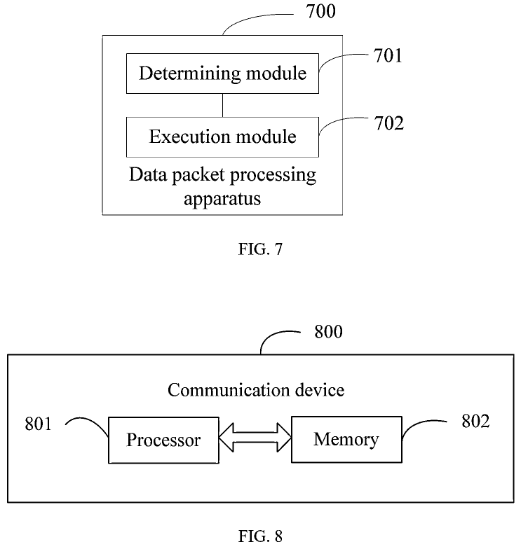

Referring to FIG. 7, FIG. 7 is a structural diagram of a data packet processing apparatus according to an embodiment of this application. As shown in FIG. 7, the data packet processing apparatus 700 includes:

a determining module 701, configured to determine that a first downlink data packet has not been successfully transmitted in a source cell, where a source network side device does not send the first downlink data packet to a target network side device of a target cell, the source cell is a source cell in a cell handover procedure, and the target cell is a target cell in the cell handover procedure; and
an execution module 702, configured to execute target behavior, where the target behavior includes at least one of the following:
discarding a second downlink data packet; and
not sending the second downlink data packet to the target network side device; where
the second downlink data packet is a downlink data packet in an association relationship with the first downlink data packet.

The data packet processing apparatus corresponds to the source network side device, or the source network side device includes the data packet processing apparatus.

In some embodiments, that the first downlink data packet has not been successfully transmitted includes at least one of the following:
the source network side device has not transmitted the first downlink data packet on an air interface of the source cell;
the source network side device has transmitted the first downlink data packet on the air interface of the source cell, but the source network side device receives a negative acknowledgement NACK sent by the terminal for the first downlink data packet, and the source network side device has not retransmitted the first downlink data packet;
the source network side device receives first indication information of a terminal, where the first indication information indicates a downlink data packet successfully received by the terminal, and the downlink data packet successfully received by the terminal does not include the first downlink data packet; and
the source network side device receives second indication information of the terminal, where the second indication information indicates a downlink data packet that is not successfully received by the terminal, and the first downlink data packet is a downlink data packet that is not successfully received by the terminal.

In some embodiments, the NACK includes N NACKs, and that the source network side device has not retransmitted the first downlink data packet includes:
the source network side device has not performed an N^{th} retransmission for the first downlink data packet; where
N is a positive integer.

In some embodiments, the second downlink data packet includes at least one of the following:
in a case that the first downlink data packet has not been successfully transmitted, a data packet that is unable to be applied by the terminal;
in a case that the first downlink data packet has not been successfully transmitted, a downlink data packet in which information is unable to be applied by the terminal; and
in a case that the first downlink data packet has not been successfully transmitted, a data packet that is unable to be correctly decoded by the terminal.

In some embodiments, the first downlink data packet and the second downlink data packet belong to a same data packet group, or the first downlink data packet and the second downlink data packet belong to associated data packet groups; or
the third downlink data packet and the fourth downlink data packet belong to a same data packet group, or the third downlink data packet and the fourth downlink data packet belong to associated data packet groups, where the third downlink data packet carries the first downlink data packet, and the fourth downlink data packet carries the second downlink data packet.

In some embodiments, the apparatus further includes:
a sending module, configured to send a fifth downlink data packet to the target network side device, where the fifth downlink data packet includes:
a downlink data packet other than the first downlink data packet and the second downlink data packet.

In some embodiments, the execution module is configured to execute the target behavior in the cell handover procedure.

The foregoing data packet processing apparatus can reduce resource overheads.

The data packet processing apparatus in this embodiment of this application may be an electronic device, for example, an electronic device with an operating system, or may be a component in the electronic device, for example, an integrated circuit or a chip. The electronic device may be a network side device.

The data packet processing apparatus provided in this embodiment of this application can implement the processes implemented in the method embodiment shown in FIG. 5, and a same technical effect is achieved. To avoid repetition, details are not provided herein again.

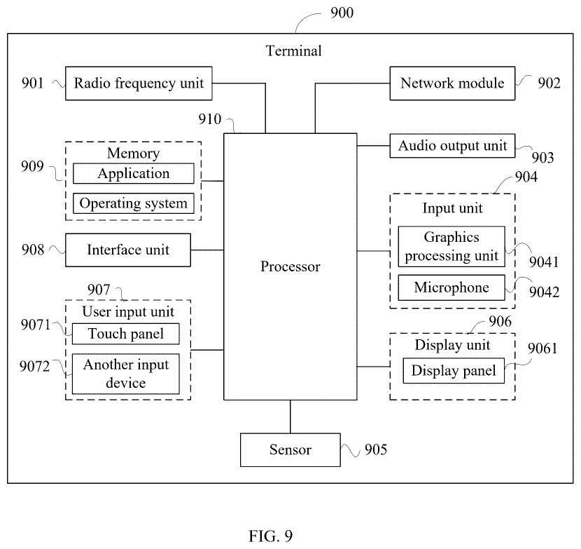

In some embodiments, as shown in FIG. 8, an embodiment of this application further provides a communication device 800, including a processor 801 and a memory 802, and the memory 802 stores a program or an instruction that can be run on the processor 801. For example, in a case that the communication device 800 is a terminal, when the program or the instruction is executed by the processor 801, the steps of the foregoing embodiment of the data packet processing method on the terminal side are implemented, and a same technical effect can be achieved. In a case that the communication device 800 is a network side device, when the program or the instruction is executed by the processor 801, the steps of the foregoing embodiment of the data packet processing method on the network side device side are implemented, and a same technical effect can be achieved. To avoid repetition, details are not described herein again.

An embodiment of this application further provides a terminal, including a processor and a communication interface. The processor or the communication interface is configured to determine that a first uplink data packet has not been successfully transmitted in a source cell, where the terminal does not transmit the first uplink data packet in a target cell, the source cell is a source cell in a cell handover procedure, and the target cell is a target cell in the cell handover procedure. The processor or the communication interface is further configured to execute target behavior, where the target behavior includes at least one of the following: discarding a second uplink data packet; and not transmitting the second uplink data packet in the target cell; where the second uplink data packet is an uplink data packet in an association relationship with the first uplink data packet. The terminal embodiment corresponds to the method embodiment on the terminal side, each implementation process and implementation of the method embodiment can be applied to the terminal embodiment, and a same technical effect can be achieved. For example, FIG. 9 is a schematic diagram of a hardware structure of a terminal according to an embodiment of this application.

The terminal 900 includes but is not limited to at least some components in a radio frequency unit 901, a network module 902, an audio output unit 903, an input unit 904, a sensor 905, a display unit 906, a user input unit 907, an interface unit 908, a memory 909, a processor 910, and the like.

A person skilled in the art may understand that the terminal 900 may further include a power supply (such as a battery) that supplies power to each component. The power supply may be logically connected to the processor 910 by using a power supply management system, to implement functions such as charging and discharging management, and power consumption management by using the power supply management system. The terminal structure shown in FIG. 9 constitutes no limitation on the terminal, and the terminal may include more or fewer components than those shown in the figure, or combine some components, or have different component arrangements. Details are not described herein.

It should be understood that, in this embodiment of this application, the input unit 904 may include a Graphics Processing Unit (GPU) 9041 and a microphone 9042, and the graphics processing unit 9041 processes image data of a still picture or a video obtained by an image capture apparatus (such as a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 and another input device 9072. The touch panel 9071 is also referred to as a touchscreen. The touch panel 9071 may include two parts: a touch detection apparatus and a touch controller. The another input device 9072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 901 may transmit the downlink data to the processor 910 for processing. In addition, the radio frequency unit 901 may send uplink data to the network side device. Generally, the radio frequency unit 901 includes but is not limited to an antenna, an amplifier, a transceiver, a coupler, a low noise amplifier, a duplexer, and the like.

The memory 909 may be configured to store a software program or an instruction and various data. The memory 909 may mainly include a first storage area for storing a program or an instruction and a second storage area for storing data. The first storage area may store an operating system, and an application or an instruction required by at least one function (for example, a sound playing function or an image playing function). In addition, the memory 909 may be a volatile memory or a non-volatile memory, or the memory 909 may include a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 909 in this embodiment of this application includes but is not limited to these memories and any memory of another proper type.

The processor 910 may include one or more processing units. In some embodiments, an application processor and a modem processor are integrated into the processor 910. The application processor mainly processes an operating system, a user interface, an application, or the like. The modem processor mainly processes a wireless communication signal, for example, a baseband processor. It may be understood that, in some embodiments, the modem processor may not be integrated into the processor 910.

The processor 910 is configured to: determine that a first uplink data packet has not been successfully transmitted in a source cell, where the terminal does not transmit the first uplink data packet in a target cell, the source cell is a source cell in a cell handover procedure, and the target cell is a target cell in the cell handover procedure; and execute target behavior, where the target behavior includes at least one of the following:
discarding a second uplink data packet; and
not transmitting the second uplink data packet in the target cell; where
the second uplink data packet is an uplink data packet in an association relationship with the first uplink data packet.

In some embodiments, that the first uplink data packet has not been successfully transmitted in the source cell includes at least one of the following:
the terminal has not transmitted the first uplink data packet on an air interface of the source cell;
the terminal has transmitted the first uplink data packet on the air interface, but the terminal receives retransmission scheduling signaling sent by a source network side device for the first uplink data packet, and before terminating data transmission with the source cell, the terminal has not performed retransmission corresponding to the retransmission scheduling signaling;
the terminal receives first indication information from the source network side device or a target network side device, where the first indication information indicates an uplink data packet successfully received by the source network side device, and the uplink data packet successfully received by the source network side device does not include the first uplink data packet; and
the terminal receives second indication information from the source network side device or the target network side device, where the second indication information indicates an uplink data packet that is not successfully received by the source network side device, and the first uplink data packet is an uplink data packet that is not successfully received by the source network side device.

In some embodiments, the retransmission scheduling signaling includes Scheduling signaling for N retransmissions, and that retransmission corresponding to the retransmission scheduling signaling has not been performed includes:
an N^{th} retransmission for the first uplink data packet has not been performed; where
N is a positive integer.

In some embodiments, the second uplink data packet includes at least one of the following:
in a case that the first uplink data packet has not been successfully transmitted, a data packet that is unable to be applied by a communication peer of the terminal;
in a case that the first uplink data packet has not been successfully transmitted, an uplink data packet in which information is unable to be applied by the communication peer of the terminal; and
in a case that the first uplink data packet has not been successfully transmitted, a data packet that is unable to be correctly decoded by the communication peer of the terminal.

In some embodiments, the first uplink data packet and the second uplink data packet belong to a same data packet group, or the first uplink data packet and the second uplink data packet belong to associated data packet groups; or
the third uplink data packet and the fourth uplink data packet belong to a same data packet group, or the third uplink data packet and the fourth uplink data packet belong to associated data packet groups, where the third uplink data packet carries the first uplink data packet, and the fourth uplink data packet carries the second uplink data packet.

In some embodiments, the radio frequency unit 901 is configured to:
send a fifth uplink data packet in the target cell, where the fifth uplink data packet includes:
an uplink data packet other than the first uplink data packet and the second uplink data packet.

In some embodiments, the executing target behavior includes:
executing the target behavior in the cell handover procedure.

The foregoing terminal can reduce resource overheads.

An embodiment of this application further provides a network side device, including a processor and a communication interface. The processor or the communication interface is configured to determine that a first downlink data packet has not been successfully transmitted in a source cell, where the source network side device does not send the first downlink data packet to a target network side device of a target cell, the source cell is a source cell in a cell handover procedure, and the target cell is a target cell in the cell handover procedure. The processor or the communication interface is further configured to execute target behavior, where the target behavior includes at least one of the following: discarding a second downlink data packet; and not sending the second downlink data packet to the target network side device; where the second downlink data packet is a downlink data packet in an association relationship with the first downlink data packet. This network side device embodiment corresponds to the foregoing method embodiment on the network side device side. Each implementation process and implementation of the foregoing method embodiment may be applicable to this network side device embodiment, and a same technical effect can be achieved.

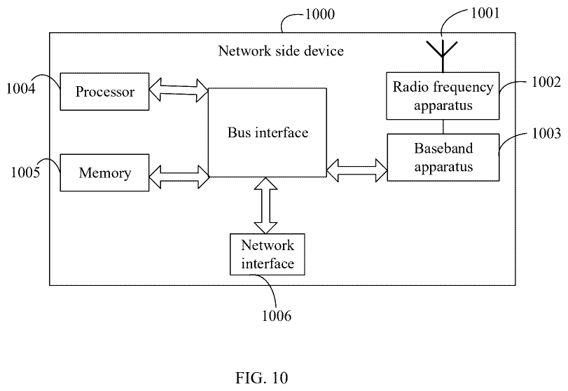

For example, an embodiment of this application further provides a network side device. As shown in FIG. 10, the network side device 1000 includes an antenna 1001, a radio frequency apparatus 1002, a baseband apparatus 1003, a processor 1004, and a memory 1005. The antenna 1001 is connected to the radio frequency apparatus 1002. In an uplink direction, the radio frequency apparatus 1002 receives information through the antenna 1001, and sends the received information to the baseband apparatus 1003 for processing. In a downlink direction, the baseband apparatus 1003 processes information that needs to be sent, and sends processed information to the radio frequency apparatus 1002. The radio frequency apparatus 1002 processes the received information, and sends processed information through the antenna 1001.

In the foregoing embodiment, the method performed by the network side device may be implemented in the baseband apparatus 1003. The baseband apparatus 1003 includes a baseband processor.

For example, the baseband apparatus 1003 may include at least one baseband board. Multiple chips are disposed on the baseband board. As shown in FIG. 10, one chip is, for example, a baseband processor, and is connected to the memory 1005 by using a bus interface, to invoke a program in the memory 1005 to perform the operations of the network device shown in the foregoing method embodiment.

The network side device may further include a network interface 1006, and the interface is, for example, a Common Public Radio Interface (CPRI).

For example, the network side device 1000 in this embodiment of this application further includes an instruction or a program that is stored in the memory 1005 and that can be run on the processor 1004. The processor 1004 invokes the instruction or the program in the memory 1005 to perform the method performed by the modules shown in FIG. 7, and a same technical effect is achieved. To avoid repetition, details are not described herein again.

The processor 1004 is configured to: determine that a first downlink data packet has not been successfully transmitted in a source cell, where a source network side device does not send the first downlink data packet to a target network side device of a target cell, the source cell is a source cell in a cell handover procedure, and the target cell is a target cell in the cell handover procedure; and execute target behavior, where the target behavior includes at least one of the following:
discarding a second downlink data packet; and
not sending the second downlink data packet to the target network side device; where
the second downlink data packet is a downlink data packet in an association relationship with the first downlink data packet.

In some embodiments, that the first downlink data packet has not been successfully transmitted includes at least one of the following:
the source network side device has not transmitted the first downlink data packet on an air interface of the source cell;
the source network side device has transmitted the first downlink data packet on the air interface of the source cell, but the source network side device receives a negative acknowledgement NACK sent by the terminal for the first downlink data packet, and the source network side device has not retransmitted the first downlink data packet;
the source network side device receives first indication information of a terminal, where the first indication information indicates a downlink data packet successfully received by the terminal, and the downlink data packet successfully received by the terminal does not include the first downlink data packet; and
the source network side device receives second indication information of the terminal, where the second indication information indicates a downlink data packet that is not successfully received by the terminal, and the first downlink data packet is a downlink data packet that is not successfully received by the terminal.

In some embodiments, the NACK includes N NACKs, and that the source network side device has not retransmitted the first downlink data packet includes:
the source network side device has not performed an N^{th} retransmission for the first downlink data packet; where
N is a positive integer.

In some embodiments, the second downlink data packet includes at least one of the following:
in a case that the first downlink data packet has not been successfully transmitted, a data packet that is unable to be applied by the terminal;
in a case that the first downlink data packet has not been successfully transmitted, a downlink data packet in which information is unable to be applied by the terminal; and
in a case that the first downlink data packet has not been successfully transmitted, a data packet that is unable to be correctly decoded by the terminal.

In some embodiments, the first downlink data packet and the second downlink data packet belong to a same data packet group, or the first downlink data packet and the second downlink data packet belong to associated data packet groups; or the third downlink data packet and the fourth downlink data packet belong to a same data packet group, or the third downlink data packet and the fourth downlink data packet belong to associated data packet groups, where the third downlink data packet carries the first downlink data packet, and the fourth downlink data packet carries the second downlink data packet.

In some embodiments, the radio frequency apparatus 1002 is configured to:
send a fifth downlink data packet to the target network side device, where the fifth downlink data packet includes:
a downlink data packet other than the first downlink data packet and the second downlink data packet.

In some embodiments, the executing target behavior includes:
executing the target behavior in the cell handover procedure.

The foregoing network side device can reduce resource overheads.

An embodiment of this application further provides a readable storage medium. The readable storage medium stores a program or an instruction, and when the program or the instruction is executed by a processor, the steps of the data packet processing method provided in the embodiments of this application are implemented.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing embodiments of the data packet processing method, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product, the computer program/program product is stored in a storage medium, and the computer program/program product is executed by at least one processor to implement the processes of the foregoing embodiment of the data packet processing method, and a same technical effect can be achieved. To avoid repetition, details are not described herein again.

An embodiment of this application further provides a data packet processing system, including a terminal and a network side device. The terminal may be configured to perform the steps of the data packet processing method on the terminal side provided in the embodiments of this application, and the network side device may be configured to perform the steps of the data packet processing method on the network side device side provided in the embodiments of this application.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is an example implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A data packet processing method, comprising:
determining, by a terminal, that a first uplink data packet has not been successfully transmitted in a source cell, wherein the terminal does not transmit the first uplink data packet in a target cell, the source cell is a source cell in a cell handover procedure, and the target cell is a target cell in the cell handover procedure; and
executing, by the terminal, target behavior, wherein the target behavior comprises at least one of the following:
discarding a second uplink data packet; or
skipping transmitting the second uplink data packet in the target cell, wherein
the second uplink data packet is an uplink data packet in an association relationship with the first uplink data packet.

2. The data packet processing method according to claim 1, wherein the first uplink data packet has not been successfully transmitted in the source cell comprises at least one of the following:
the terminal has not transmitted the first uplink data packet on an air interface of the source cell;
the terminal has transmitted the first uplink data packet on the air interface, but the terminal receives retransmission scheduling signaling sent by a source network side device for the first uplink data packet, and before terminating data transmission with the source cell, the terminal has not performed retransmission corresponding to the retransmission scheduling signaling;
the terminal receives first indication information from the source network side device or a target network side device, wherein the first indication information indicates an uplink data packet successfully received by the source network side device, and the uplink data packet successfully received by the source network side device does not comprise the first uplink data packet; or
the terminal receives second indication information from the source network side device or the target network side device, wherein the second indication information indicates an uplink data packet that is not successfully received by the source network side device, and the first uplink data packet is an uplink data packet that is not successfully received by the source network side device.

3. The data packet processing method according to claim 2, wherein the retransmission scheduling signaling comprises scheduling signaling for N retransmissions, and the retransmission corresponding to the retransmission scheduling signaling has not been performed comprises:
an N^{th} retransmission for the first uplink data packet has not been performed, wherein
N is a positive integer.

4. The data packet processing method according to claim 1, wherein the second uplink data packet comprises at least one of the following:
when the first uplink data packet has not been successfully transmitted, an uplink data packet that is unable to be applied by a communication peer of the terminal;
when the first uplink data packet has not been successfully transmitted, an uplink data packet in which information is unable to be applied by the communication peer of the terminal; or
when the first uplink data packet has not been successfully transmitted, an uplink data packet that is unable to be correctly decoded by the communication peer of the terminal.

5. The data packet processing method according to claim 1, wherein the first uplink data packet and the second uplink data packet belong to a same data packet group, or the first uplink data packet and the second uplink data packet belong to associated data packet groups; or
the third uplink data packet and the fourth uplink data packet belong to a same data packet group, or the third uplink data packet and the fourth uplink data packet belong to associated data packet groups, wherein the third uplink data packet carries the first uplink data packet, and the fourth uplink data packet carries the second uplink data packet.

6. The data packet processing method according to claim 1, further comprising:
sending, by the terminal, a fifth uplink data packet in the target cell, wherein the fifth uplink data packet comprises an uplink data packet other than the first uplink data packet and the second uplink data packet.

7. The data packet processing method according to claim 1, wherein the executing, by the terminal, target behavior comprises:
executing, by the terminal, the target behavior in the cell handover procedure.

8. A data packet processing method, comprising:
determining, by a source network side device, that a first downlink data packet has not been successfully transmitted in a source cell, wherein the source network side device does not send the first downlink data packet to a target network side device of a target cell, the source cell is a source cell in a cell handover procedure, and the target cell is a target cell in the cell handover procedure; and
executing, by the source network side device, target behavior, wherein the target behavior comprises at least one of the following:
discarding a second downlink data packet; or
skipping sending the second downlink data packet to the target network side device, wherein
the second downlink data packet is a downlink data packet in an association relationship with the first downlink data packet.

9. The data packet processing method according to claim 8, wherein the first downlink data packet has not been successfully transmitted comprises at least one of the following:
the source network side device has not transmitted the first downlink data packet on an air interface of the source cell;
the source network side device has transmitted the first downlink data packet on the air interface of the source cell, but the source network side device receives a Negative Acknowledgement (NACK) sent by the terminal for the first downlink data packet, and the source network side device has not retransmitted the first downlink data packet;
the source network side device receives first indication information of a terminal, wherein the first indication information indicates a downlink data packet successfully received by the terminal, and the downlink data packet successfully received by the terminal does not comprise the first downlink data packet; or
the source network side device receives second indication information of the terminal, wherein the second indication information indicates a downlink data packet that is not successfully received by the terminal, and the first downlink data packet is a downlink data packet that is not successfully received by the terminal.

10. The data packet processing method according to claim 9, wherein the NACK comprises N NACKs, and that the source network side device has not retransmitted the first downlink data packet comprises:
the source network side device has not performed an N^{th} retransmission for the first downlink data packet, wherein
N is a positive integer.

11. The data packet processing method according to claim 8, wherein the second downlink data packet comprises at least one of the following:
when the first downlink data packet has not been successfully transmitted, a downlink data packet that is unable to be applied by the terminal;
when the first downlink data packet has not been successfully transmitted, a downlink data packet in which information is unable to be applied by the terminal; or
when the first downlink data packet has not been successfully transmitted, a downlink data packet that is unable to be correctly decoded by the terminal.

12. The data packet processing method according to claim 8, wherein the first downlink data packet and the second downlink data packet belong to a same data packet group, or the first downlink data packet and the second downlink data packet belong to associated data packet groups; or
the third downlink data packet and the fourth downlink data packet belong to a same data packet group, or the third downlink data packet and the fourth downlink data packet belong to associated data packet groups, wherein the third downlink data packet carries the first downlink data packet, and the fourth downlink data packet carries the second downlink data packet.

13. The data packet processing method according to claim 8, further comprising:
sending, by the source network side device, a fifth downlink data packet to the target network side device, wherein the fifth downlink data packet comprises a downlink data packet other than the first downlink data packet and the second downlink data packet.

14. The data packet processing method according to claim 8, wherein the executing, by the source network side device, target behavior comprises:
executing, by the source network side device, the target behavior in the cell handover procedure.

15. A terminal, comprising a processor and a memory storing instructions, wherein the instructions, when executed by the processor, cause the processor to perform operations comprising:
determining that a first uplink data packet has not been successfully transmitted in a source cell, wherein the terminal does not transmit the first uplink data packet in a target cell, the source cell is a source cell in a cell handover procedure, and the target cell is a target cell in the cell handover procedure; and
executing target behavior, wherein the target behavior comprises at least one of the following:
discarding a second uplink data packet; or
skipping transmitting the second uplink data packet in the target cell, wherein
the second uplink data packet is an uplink data packet in an association relationship with the first uplink data packet.

16. The terminal according to claim 15, wherein the first uplink data packet has not been successfully transmitted in the source cell comprises at least one of the following:
the terminal has not transmitted the first uplink data packet on an air interface of the source cell;
the terminal has transmitted the first uplink data packet on the air interface, but the terminal receives retransmission scheduling signaling sent by a source network side device for the first uplink data packet, and before terminating data transmission with the source cell, the terminal has not performed retransmission corresponding to the retransmission scheduling signaling;
the terminal receives first indication information from the source network side device or a target network side device, wherein the first indication information indicates an uplink data packet successfully received by the source network side device, and the uplink data packet successfully received by the source network side device does not comprise the first uplink data packet; or
the terminal receives second indication information from the source network side device or the target network side device, wherein the second indication information indicates an uplink data packet that is not successfully received by the source network side device, and the first uplink data packet is an uplink data packet that is not successfully received by the source network side device.

17. The terminal according to claim 16, wherein the retransmission scheduling signaling comprises scheduling signaling for N retransmissions, and the retransmission corresponding to the retransmission scheduling signaling has not been performed comprises:
an N^{th} retransmission for the first uplink data packet has not been performed, wherein
N is a positive integer.

18. The terminal according to claim 15, wherein the second uplink data packet comprises at least one of the following:
when the first uplink data packet has not been successfully transmitted, an uplink data packet that is unable to be applied by a communication peer of the terminal;
when the first uplink data packet has not been successfully transmitted, an uplink data packet in which information is unable to be applied by the communication peer of the terminal; or
when the first uplink data packet has not been successfully transmitted, an uplink data packet that is unable to be correctly decoded by the communication peer of the terminal.

19. The terminal according to claim 15, wherein the first uplink data packet and the second uplink data packet belong to a same data packet group, or the first uplink data packet and the second uplink data packet belong to associated data packet groups; or
the third uplink data packet and the fourth uplink data packet belong to a same data packet group, or the third uplink data packet and the fourth uplink data packet belong to associated data packet groups, wherein the third uplink data packet carries the first uplink data packet, and the fourth uplink data packet carries the second uplink data packet.

20. The terminal according to claim 15, wherein the instructions, when executed by the processor, cause the processor to further perform operations comprising:
sending a fifth uplink data packet in the target cell, wherein the fifth uplink data packet comprises an uplink data packet other than the first uplink data packet and the second uplink data packet.
